(19) United States
(12) Patent Application Publication
(10) Pub. No.: US 2012/0282092 A1
(43) Pub. Date: Nov. 8, 2012

(54) METHOD AND DEVICES FOR COMPACT FORCED VELOCITY TURBINES

(76) Inventor: Jason Swist, Edmonton (CA)

(21) Appl. No.: 13/460,951

(22) Filed: May 1, 2012

Related U.S. Application Data
(60) Provisional application No. 61/481,297, filed on May 2, 2011.

(51) Int. Cl. F03D 1/00

(52) U.S. Cl. 416/1

(57) ABSTRACT

Betz's law establishes an efficiency limit of 0.59 for wind turbines. Increasing turbine output power requires making the blades larger thereby increasing the radius of the turbine, which increases power by that factor squared, or by increasing the velocity of the air which increases the power according to that factor cubed. It would be beneficial to provide a wind turbine that overcame some of the disadvantages of prior art horizontal and vertical turbines including but not limited to, installation infrastructure, operation in non-laminar flow environments, operation over a wider range of air velocities, operation in low air velocity that defines many regions of the world and continental United States, and capable of supporting installations over a wide range of instances from discrete residential/commercial installations to large wind farms as well as providing increased output power through increased air velocities generated within the turbines.

### CROSS-REFERENCE TO RELATED APPLICATIONS

This patent application claims the benefit of U.S. Provisional Patent Application U.S. 61/481,297 filed May 2, 2011 entitled “Methods and Devices for Compact Forced Velocity Turbines.”

### FIELD OF THE INVENTION

This invention relates to wind turbines and more specifically compact turbines with forced velocity increase.

### BACKGROUND OF THE INVENTION

Wind energy has been harnessed for centuries and used for a variety of useful purposes including propelling sailing ships to newly discovered continents, grinding grain, pumping water, and generating electricity. Recently large propeller-type horizontal axis wind turbine (HAWT) devices mounted on towers used to turn electrical generators have become a familiar site either individually or in arrays, commonly referred to as wind farms, to provide a portion of the electrical power generated into the large electrical distribution grids of a city, territory, region, or country.

Wind farms where significant numbers of these wind turbines can be located in areas with high average wind speeds have demonstrated considerable generating capability. These may consist of several hundred individual wind turbines, and cover an extended area of hundreds of square miles, although the land between the turbines may be used for agricultural or other purposes. They may also be located offshore. Many of the largest operational onshore wind farms are located in the USA. As of November 2010, the Roscoe Wind Farm was the largest onshore wind farm in the world operating at 781.5 MW, followed by the Horse Hollow Wind Energy Center at 735.5 MW. In terms of offshore wind farms as of November 2010, the Thanet Offshore Wind Project in the United Kingdom was the largest at 300 MW, followed by Horns Rev II at 209 MW in Denmark.

Accordingly wind energy acts as a potential substitute for at least a portion of the power generated by burning fossil fuels in conventional power plants in combination with other approaches including but not limited to geothermal and solar. These energy generation approaches instead of fossil fuels reduces the production of atmospheric pollution including hydrocarbons, carbon monoxide, particulates, and acid rain, for example as well as reducing the production of greenhouse gasses, i.e. carbon dioxide. Additionally, these approaches which are being driven by environmental factors today provide a long term global energy production strategy for the exhaustion of fossil fuels and an alternative to nuclear power. Wind energy instead of nuclear beneficially would avoid the risk of accidents and terrorist acts, as well as the long-term commitment of future generations associated with the production of radioactive waste.

Despite the significant political pressure environmental and global climate issues have and the stated commitments of governments to reduce dependency on fossil fuels in 2009 on 73,886 thousand MWhrs of electricity were generated in the United States to address an annual consumption 3,723,803 thousand MWhrs, just under 2%. Of this approximately 90% was generated by private companies and not the public utilities themselves. That is not to say that wind power is not being invested in as it has been the fastest-growing source of new electric power generation for several years. In 2009, generation from wind power increased 33.5 percent over 2008 and followed year-over-year generation gains of 60.7 percent in 2008, 29.6 percent in 2007, and 49.3 percent in 2006 respectively.

In the United States in 2009 (and 2010), wind generators were eligible for Federal production and investment tax credits or a cash grant in lieu of those tax credits. Further since passage of the 2005 Energy Policy Act (EPACT2005), interest-free financing via Clean Renewable Energy Bonds (CREBs) has been available to government entities investing in wind energy production whilst the 2002 and 2008 Farm Bills both contained grant and loan guarantee provisions for wind projects for farmers, ranchers, and other rural businesses. Renewable generation is fostered by both Federal incentives and State renewable portfolio standards.

So with such long-standing Federal and State incentives the rapid expansion in wind energy production over 2006-2009 may be explained. But with such generous incentives what limited the increase? Amongst the issues for conventional large HAWT devices and wind farms is the annual average wind across the contiguous United States as illustrated in FIG. 1A (FIG. 2A of “Wind Energy Resource Atlas of the United States” by National Renewable Energy Laboratory http://rredc.nrel.gov/wind/pubs/atlas). As evident from FIG. 1A there are large areas of the contiguous United States that have very low average annual wind except for vary narrow bands along the coast, upper north-east (New England), upper north west (Washington and Oregon states) and a belt down the centre associated primarily with the eastern edge of the Rockies.

Referring to FIG. 1B there is shown the 2009 levelized Cost per MWhr of generating electricity for systems entering production in 2016 based upon the Department of Energy “Annual Energy Outlook 2011” issued in 2010 (DOE/EIA-0383). Accordingly, continental US based production cost with wind turbines is approximately US$97 per MWhr. By contrast coal is approximately US$95, natural gas approximately US$65 and nuclear approximately US$114. By contrast the dominant alternative environmentally “friendly” technology of solar photovoltaic is approximately US$211 as a stand-alone and approximately US$312 when combined with thermal generation. Accordingly wind energy stands very competitive to today's fossil fuels and nuclear energy and ahead of the solar technology.

However, as evident from FIG. 1A certain locations are far better than others for locating devices that harness wind energy, and available locations with adequate and relatively consistent wind speeds are limited. Further, it is evident that wind velocities at 50 m (approximately 165 feet) and hence power generation at 10 m (approximately 33 feet). Thus to maximize power generation turbine towers must be very tall plus typically should be spaced apart from one another by a fairly substantial distance to avoid overly impacting adjacent turbines.

Consequently, the number of wind turbines that have been installed in a particular area of land has been rather limited. Thus, a need exists, or potential for benefit, to be able to improve the power production capability of a wind farm, or of a particular area of available land which may not today support state-of-the-art HAWT devices. Additionally, as evident from the issues identified below for HAWT and vertical axis wind turbines (VAWT) from environmental, cost, and political issues it would be beneficial if wind power could exploit lower structures. Further, it would be beneficial to allow greater power production per area of land, more wind turbines per area of land, less interference between adjacent wind turbines, or wherein adjacent turbines improve wind speeds through each other, at least in some cases, rather than reducing wind speeds through each other.

Considering initially HAWT devices these include a main rotor shaft, a gear box, an electrical generator of some type and in many cases, a solid state power converter, The turbine is mounted on top of a tall tower with the main rotor shaft pointed into the wind direction. For HAWT devices with smaller blades these may in many instances be pointed by a simple wind vane, while the pointing of larger turbines typically is performed by a wind direction sensor coupled to a closed loop controlled servo drive motor or they are simply fixed in orientation for the prevalent wind direction, e.g. coastal deployments.

Almost all HAWTs are equipped with three rotor blades where individual rotor blade lengths may range from 65 to 130 feet or more and rotate from 10 to 25 rpm. As known in the prior art, this rather complex and relatively heavy equipment package usually is installed on top of tubular towers ranging in height from 150 to 300 feet to access the higher average winds at these heights than close to the ground. Modern wind turbines also are equipped with a high wind shut down feature, or governor, to prevent catastrophic damage due to unexpectedly high wind velocities. The wind shut down velocity typically is between 25 and 30 meters per second (approximately 55 to 65 miles per hour).

The common problems associated with HAWT devices include. but are not limited to:
a) cannot efficiently operate in turbulent wind conditions encountered close to the ground requiring laminar flow for efficient operation
b) the large dimensions of tall towers and associated blades are difficult and expensive to handle and transport such that these can range between 30% to 40% of the basic hardware cost depending on the location and topography of the installation site;
c) tall HAWT devices are extremely expensive to install, particularly in topographically challenging and remote terrains;
d) substantial tower foundation construction required to support tall HAWT structures and prone to damage;
e) maintenance is very expensive and has generated an entirely new industry to support them;
f) HAWT devices directly and detrimentally affect military and commercial air traffic control and safety based on their interference with radar technology;
g) environmental groups oppose them due to their adverse and detrimental impact on the population and migration of birds, landscape, etc;
h) tall HAWT devices, especially in wind farms, are obtrusively visible across large areas, disrupting the appearance of the landscape and in numerous cases causing local opposition to their construction;
i) cyclic stresses, fatigue and vibration are a major cause of failure of HAWT devices.

Some industry estimates are that why 15% or more of HAWT devices may be out of service at any one time in major installations. In comparison VAWT devices rotate on a vertical rotor shaft and are less commonly used for various reasons today. The technical problems associated with VAWT devices typically include, but are not limited to:
a) VAWT devices are typically about 50% less efficient than a HAWT due to higher blade drag while rotating in the wind;
b) VAWT devices are typically not packaged and installed on towers such that they are not able to take advantage of stronger, more laminar, wind conditions at higher elevations although this is an engineering challenge that does not limit their deployment it does add to cost, complexity, failure mechanisms, and opposition;
c) VAWT devices cannot efficiently operate in turbulent wind conditions typically encountered near the ground;
d) some VAWT devices have a high starting torque and require auxiliary energy sources to get started;
e) VAWT devices may require guy cables to hold them in place adding additional load to the bottom bearing of the VWT which is particularly so in the event of strong wind gusts as the bearing absorbs the total weight of the turbine rotor; and
f) superstructures may be required to support and hold the top bearing in place.

Whilst wind turbines have their limitations as described above, they remain an important way of converting the mechanical energy of the wind into electrical energy. However, wind turbines have further limitations imposed by the laws of physics that cannot be easily overcome. For example, Betz's law states that the maximum power P that can be extracted by any wind turbine from the free flow of wind is given by the following equation.

$$P = \frac{1}{2} α ρ π {r}^{2} {v}^{3} \qquad ( 1 )$$

where P is the power (watts), α an efficiency factor based on the design of the wind turbine as defined by Betz's law, ρ is the density of air (kg/m3), r the radius of the wind turbine blade path (m), and v is the wind velocity (m/s).

Betz's law states that the efficiency factor α cannot exceed 0.59 regardless of the type and design of the wind turbine. Accordingly, it would be evident that increasing the output power of a wind turbine can be achieved either by increasing the efficiency factor to within predetermined limits, which is a linear increasing, making the blades larger thereby increasing the radius of the turbine which increases power by that factor squared, or by increasing the velocity of the air which increases the power according to that factor cubed. Accordingly a 60% increase in air velocity is equivalent to doubling the radius of the turbine.

It would be beneficial therefore to provide a wind turbine that overcame some of the disadvantages of prior art HAWT/VAWT devices including but not limited to, installation infrastructure, operation in non-laminar flow environments, operation over a wider range of air velocities, operation in low air velocity that defines many regions of the world and continental United States, and capable of supporting installations over a wide range of instances from discrete residential/commercial installations to large wind farms. It would be further beneficial if the wind turbine could be deployed in continental and offshore environments without significant modifications.

### SUMMARY OF THE INVENTION

It is an object of the present invention to provide wind turbines addressing limitations in the prior art and specifically to provide compact turbines with forced velocity increase.

In accordance with an embodiment of the invention there is provided a method comprising:
providing a first rotor for receiving an air flow and generating rotation of a first shaft in dependence upon the first rotor rotating with the air flow;
providing a second shaft having at least a first compressor rotor coupled to the first shaft wherein the first compressor rotor acts to adjusted a characteristic of the air flow after the first compressor rotor to create an adjusted air flow;
providing a turbine rotor receiving the adjusted air flow and rotating a third shaft at a rate established in dependence upon at least the adjusted air flow;
providing a generator providing an electrical output in dependence upon the rotation of the third shaft.

In accordance with an embodiment of the invention there is provided a method comprising:
providing a first compressor for receiving a first air flow and generating a compressed air flow therefrom;
providing an annular air outlet connected to the first compressor for receiving the compressed air flow and feeding the compressed air flow as an annular flow into a turbine shaft;
providing a turbine rotor disposed within the turbine shaft for receiving the annular air flow and entrapped air generated by the compressed air flow within the turbine shaft and generating a rotation of a first shaft in dependence upon the turbine rotor rotating with the mixed annular air flow and entrapped air;
providing a generator either linked to the turbine rotor or comprising the turbine rotor for generating an electrical output in dependence upon the rotation rate of the turbine rotor.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts the annual average wind power for the continental United States;

FIG. 1B depicts the projected levelized cost of generating electricity for different technologies in 2016;

FIG. 2A depicts unshrouded (open) wind turbines according to the prior art;

FIG. 2B depicts shrouded (ducted) wind turbines according to the prior art;

FIG. 3 depicts a wind turbine according to an embodiment of the invention;

FIGS. 4A and 4B depict wind turbines according to embodiment of the invention with entrapment and single or multiple turbines;

FIGS. 5A and 5B depict wind turbines according to embodiments of the invention with entrapment and secondary Venturi;

FIGS. 6A and 6B depict wind turbines according to embodiments of the invention with forced entrapment;

FIG. 7 depicts a wind turbine array according to an embodiment of the invention wherein a basic turbine unit is repeated but provides dual functionality;

FIG. 8 depicts an alternate generator concept according to an embodiment of the invention; and

FIG. 9 depicts a shroud/air channel design according to an embodiment of the invention.

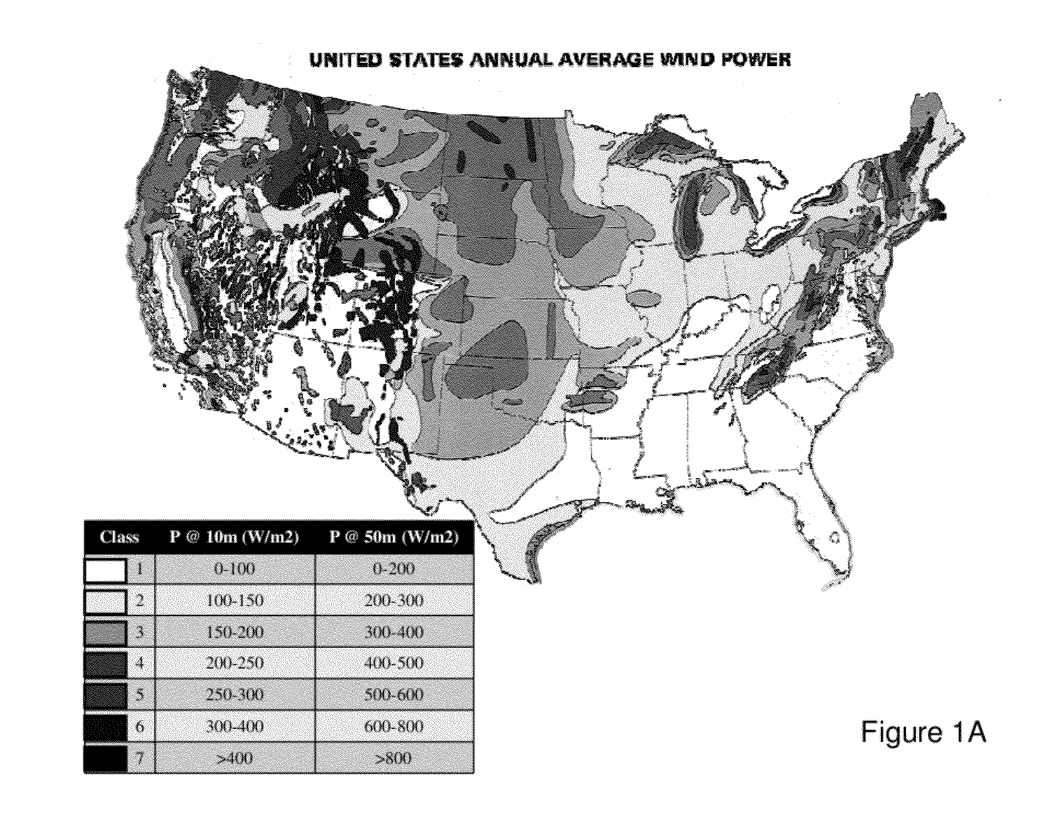

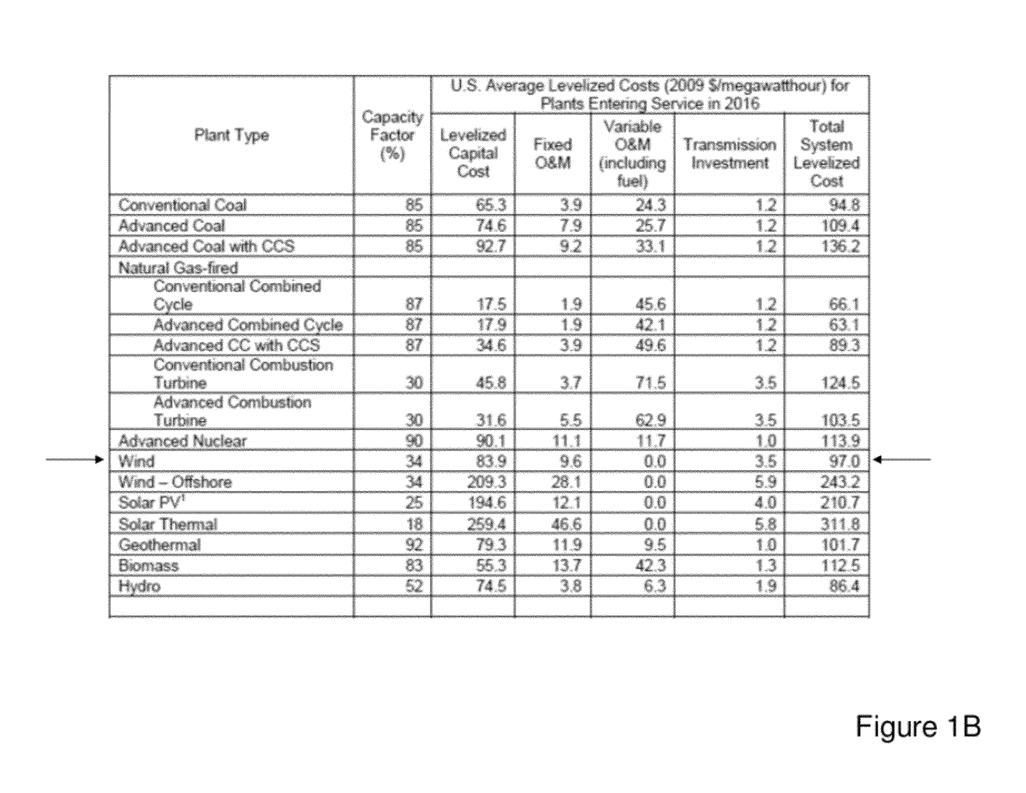

### DETAILED DESCRIPTION

The present invention relates to wind turbines and more specifically compact turbines with forced velocity increase.

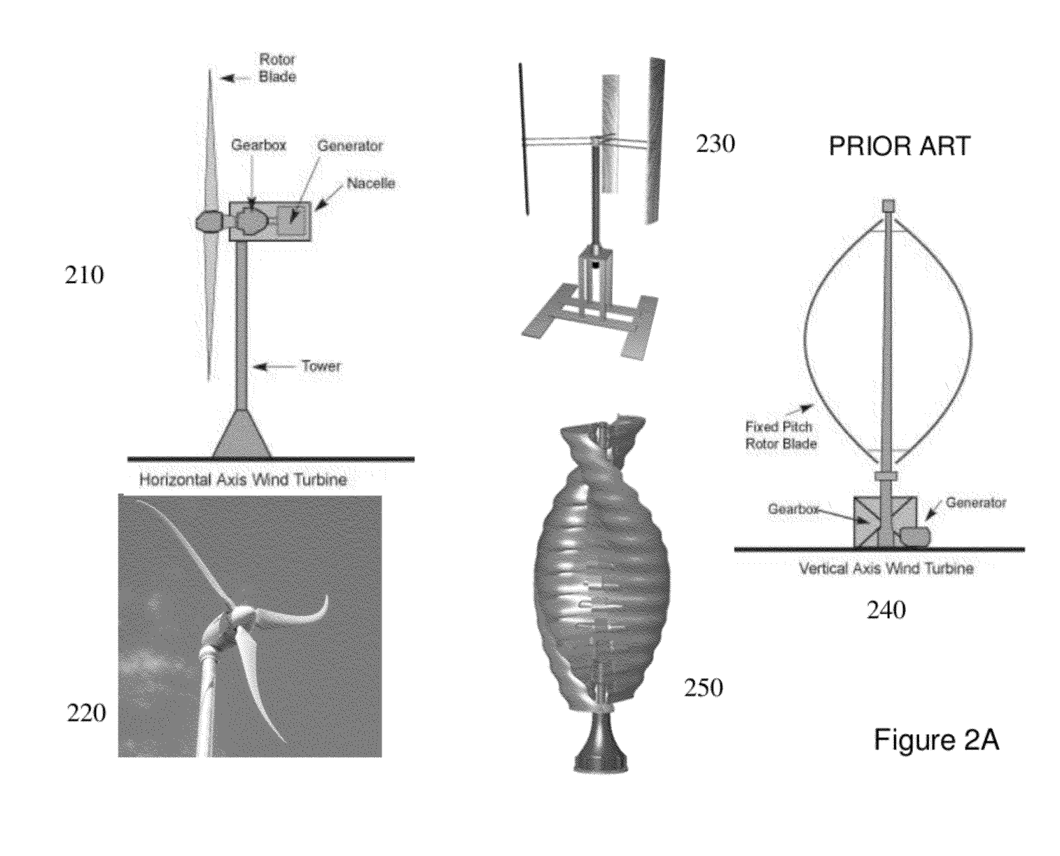

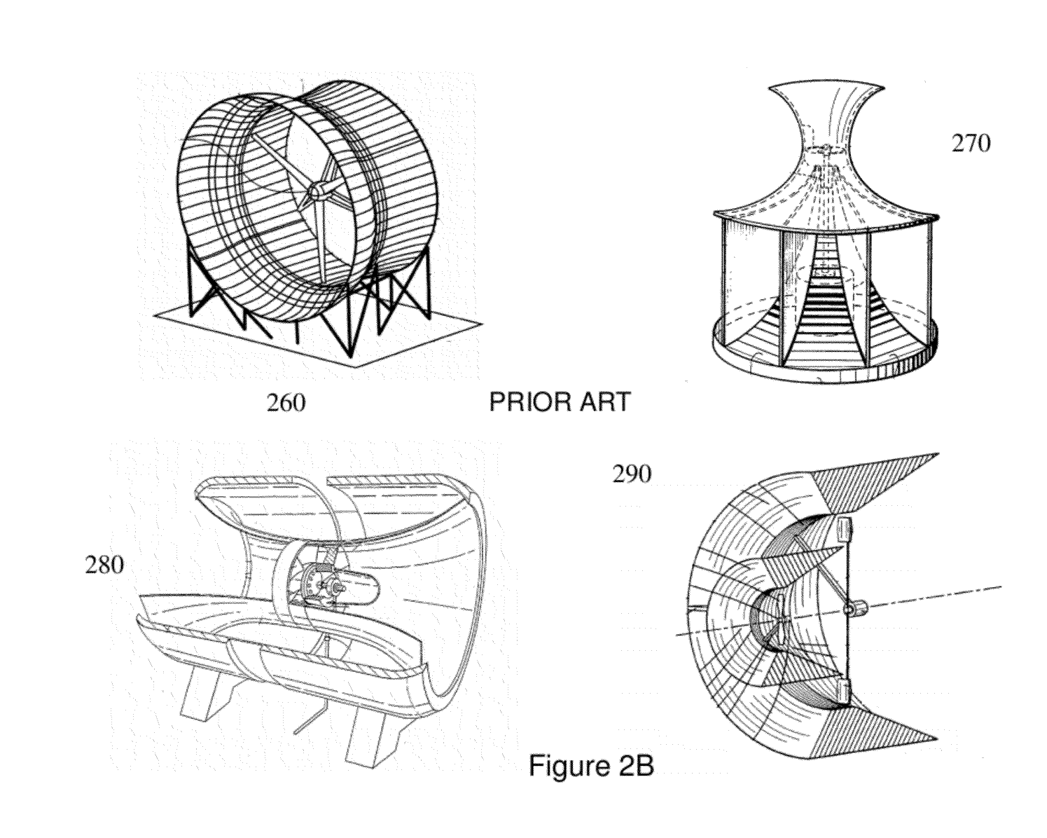

Referring to FIG. 2A there are depicted unshrouded (open) wind turbines according to the prior art including a HAWT structures 210 and 220, giromill 230, Darrieus turbine 240 and a Savonius turbine 250. The giromill 230, Darrieus turbine 240 and Savonius turbine 250 being VAWT devices. All of these wind turbines operate at the air velocity of the natural environment, i.e. the wind blowing, as there is no shroud around the turbine allowing the air speed to be artificially increased through the Venturi effect.

Now referring to FIG. 2B there are shrouded (ducted) wind turbines according to the prior art. First Venturi turbine 260 employs a shroud to funnel the air thereby increasing air speed through the Venturi effect as taught by Reidy et al in U.S. Pat. No. 7,484,363 entitled “Wind Energy Harnessing Apparatuses, Systems, Methods and Improvements.” Second Venturi turbine 270 according to the prior art of Payne in U.S. Pat. No. 4,508,973 entitled “Wind Turbine Electric Generator” addresses the issue over wind direction by providing an omnidirectional structure wherein each segment around the structure narrows as it impinges the central single impeller. Third Venturi turbine 280, actually intended for use in water but applicable to air as another fluid medium, provides increased reduction of the central channel from the input throat to the turbine blades. Third Venturi turbine 280 being taught by Susman in US Patent Application 2005/0,001,432 entitled “Power Generator and Turbine Unit.” Fourth Venturi turbine 290 according to Finney in U.S. Pat. No. 5,464,320 entitled “Superventuri Power Source” teaches to an initial Venturi fed turbine coupled to a secondary turbine wherein the Venturi effect is not present and accordingly a larger second turbine blade is employed.

Accordingly it would be evident to one skilled in the art that the increased air velocity in the prior art solutions is derived solely from Venturi effect in relatively moderate reduction ratio, i.e. ratio of starting shroud diameter to diameter of turbine. As noted supra the power of a wind turbine increases as the cube of the air velocity such that if additional velocity increase can be provided further increases in power output can be achieved.

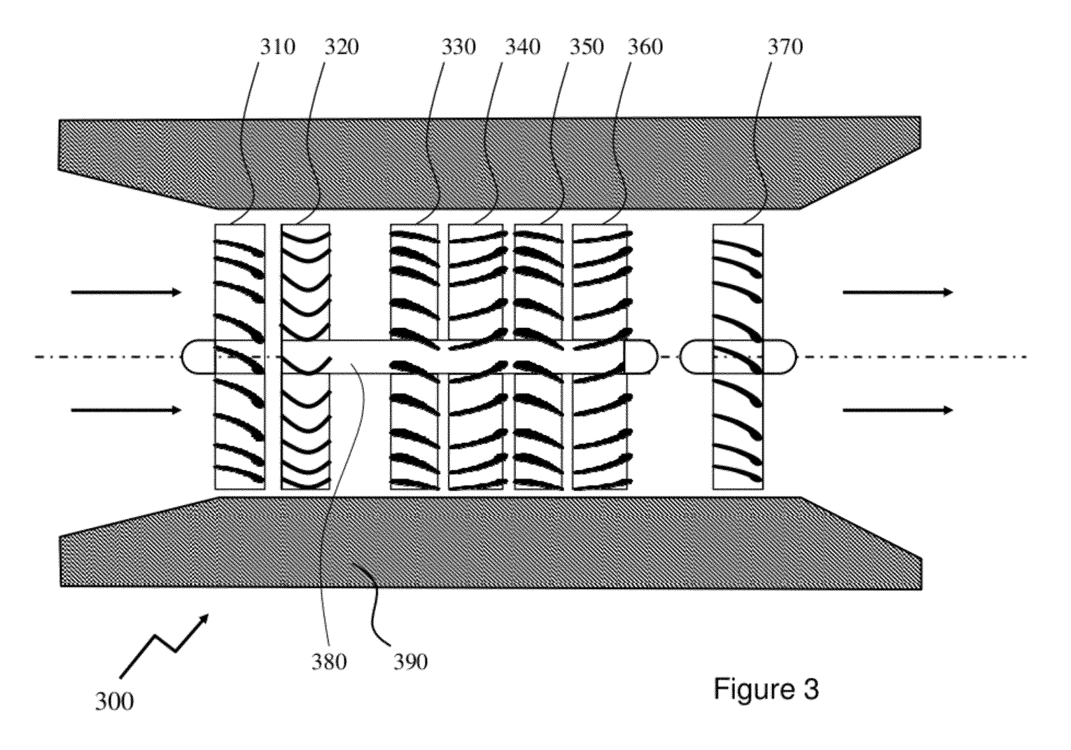

Referring to FIG. 3 there is depicted a wind turbine 300 according to an embodiment of the invention. As shown there is an outer shroud 390 to the wind turbine 300 wherein a Venturi effect is provided at the input through a reduction in the inner diameter of the outer shroud 390 therein increasing the air speed at the throat of the wind turbine 300 where the air initially impacts stator 310 that directs the air flow onto rotor 320 therein inducing rotation of the shaft 380 within the air turbine 300. The air flowing past stator 310 and rotor 320 then impacts in sequence first compression blade 330, first static blade 340, second compression blade 350, and second static blade 360 that act to increase the air flow through the compression of the air therein creating a draw effect from the throat of the wind turbine 300. The high speed compressed air now exiting the second static blade 360 impacts generator blade 370 causing it to rotate and generate electricity through the known dynamo/generator effect of a coil and magnet rotating relative to one another. The generator not shown for clarity.

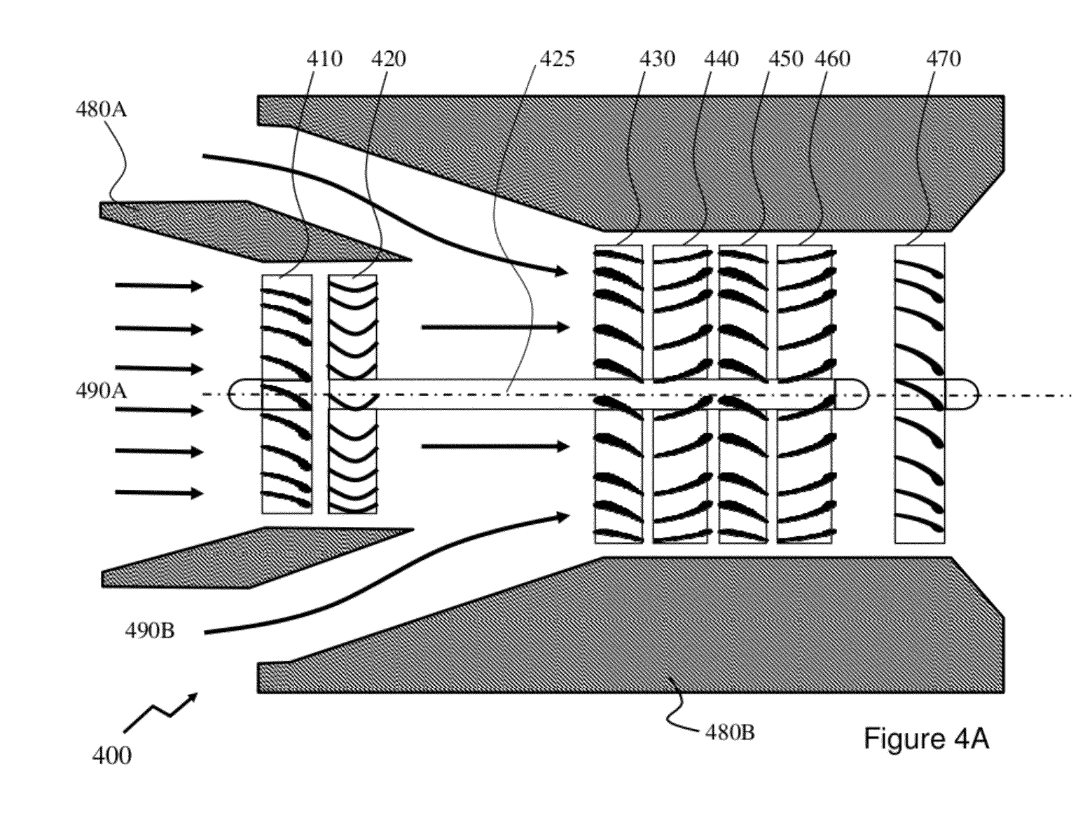

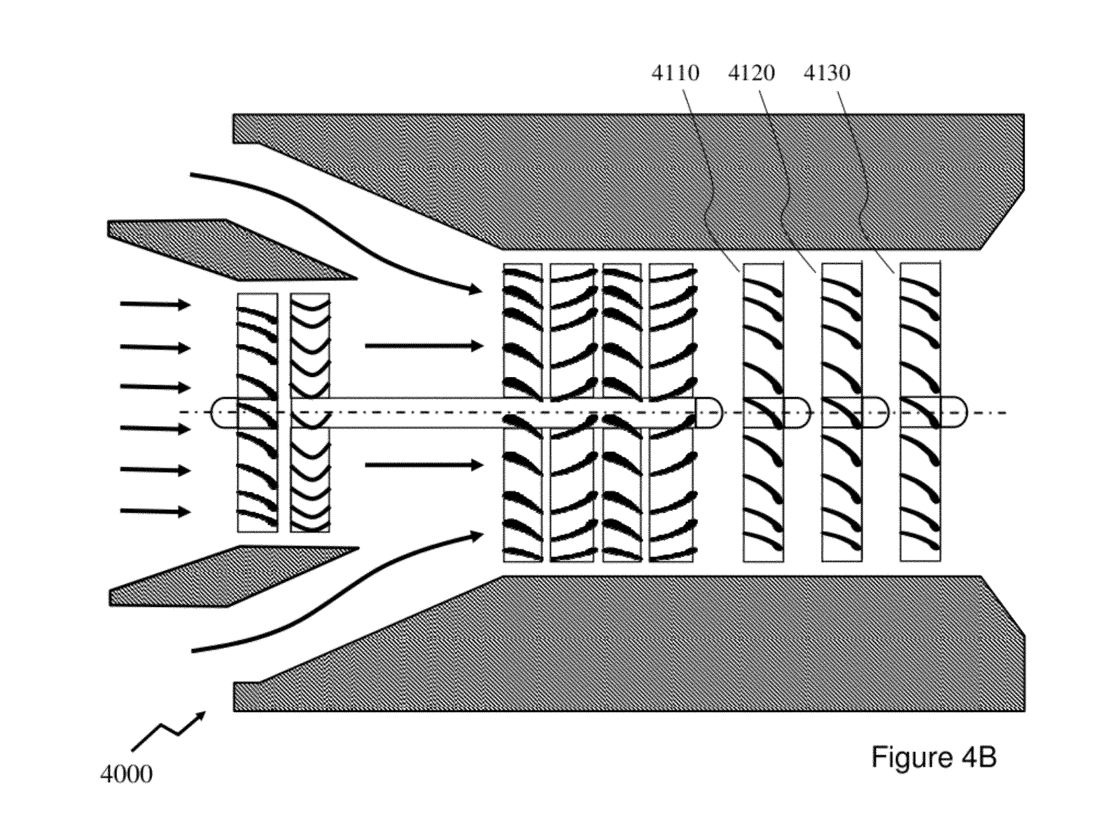

Referring to FIG. 4A there is depicted a wind turbine 400 according to an embodiment of the invention. As shown the outer shroud is comprised of a first section 480A and second section 480B for the wind turbine 400 wherein a Venturi effect is provided at the input through a reduction in the inner diameter of the first section 480A therein increasing the air speed at the throat of the wind turbine 400 where the air 490A initially impacts stator 410 that directs the air flow onto rotor 420 therein inducing rotation of the shaft 425 within the air turbine 400. The air flowing past stator 410 and rotor 420 then impacts in sequence first compression blade 430, first static blade 440, second compression blade 450, and second static blade 460 that act to increase the air flow through the compression of the air therein creating a draw effect from the throat of the wind turbine 400. The high speed compressed air now exiting the second static blade 460 impacts generator blade 470 causing it to rotate and generate electricity through the known dynamo/generator effect of a coil and magnet rotating relative to one another. The generator not shown for clarity.

However, unlike wind turbine 300 with a single continuous shroud 300 the wind turbine 400 has first and second sections 480A and 480B. The resulting channel within the outer shroud between rotor 420 and first compression blade 430 with increased air flow from the preceding Venturi effect results in a reduced pressure in between the rotor 420 and first compression blade 430 thereby causing secondary air flow 490B to be drawn into the wind turbine 400 increasing the overall air in the second stage of compression and generation as it combines with primary air flow 490A.

Now referring to FIG. 4B there is depicted a wind turbine 4000 according to an embodiment of the invention wherein the single generator blade 470 of FIG. 4A is now replaced by first to third turbines 4110, 4120 and 4130 respectively providing increased production from the wind turbine 4000.

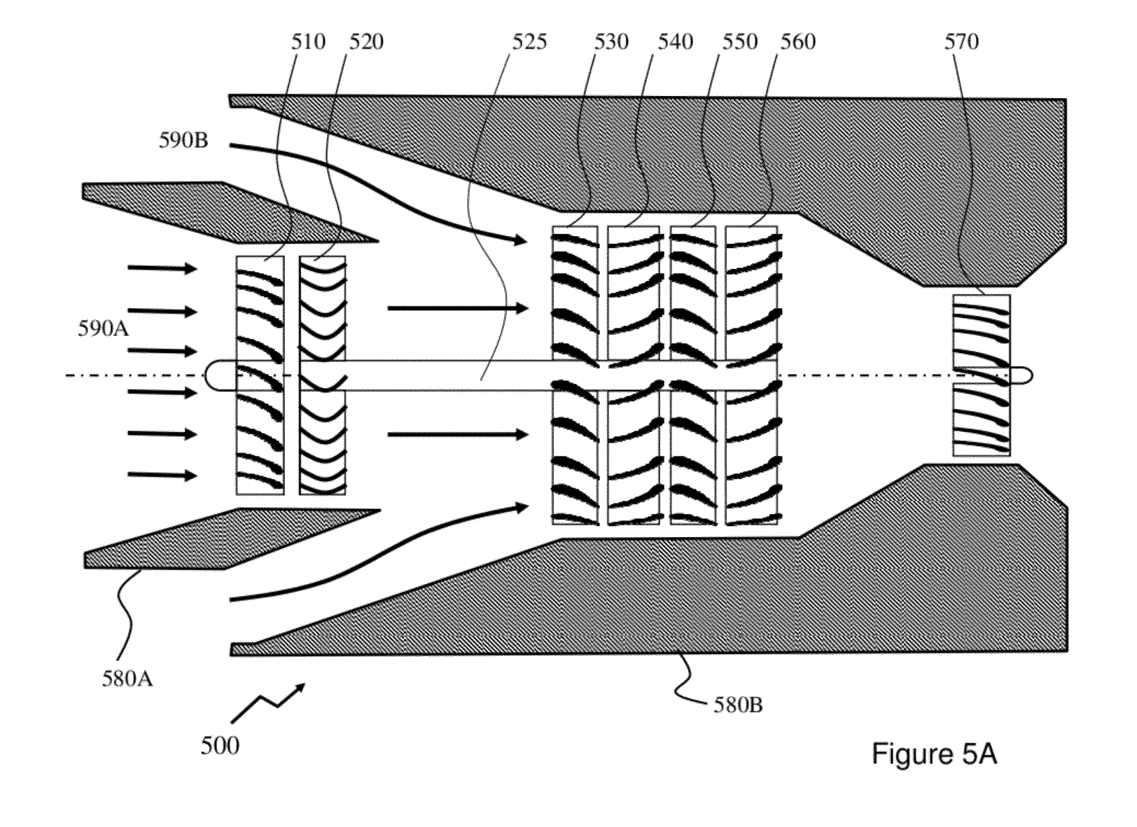

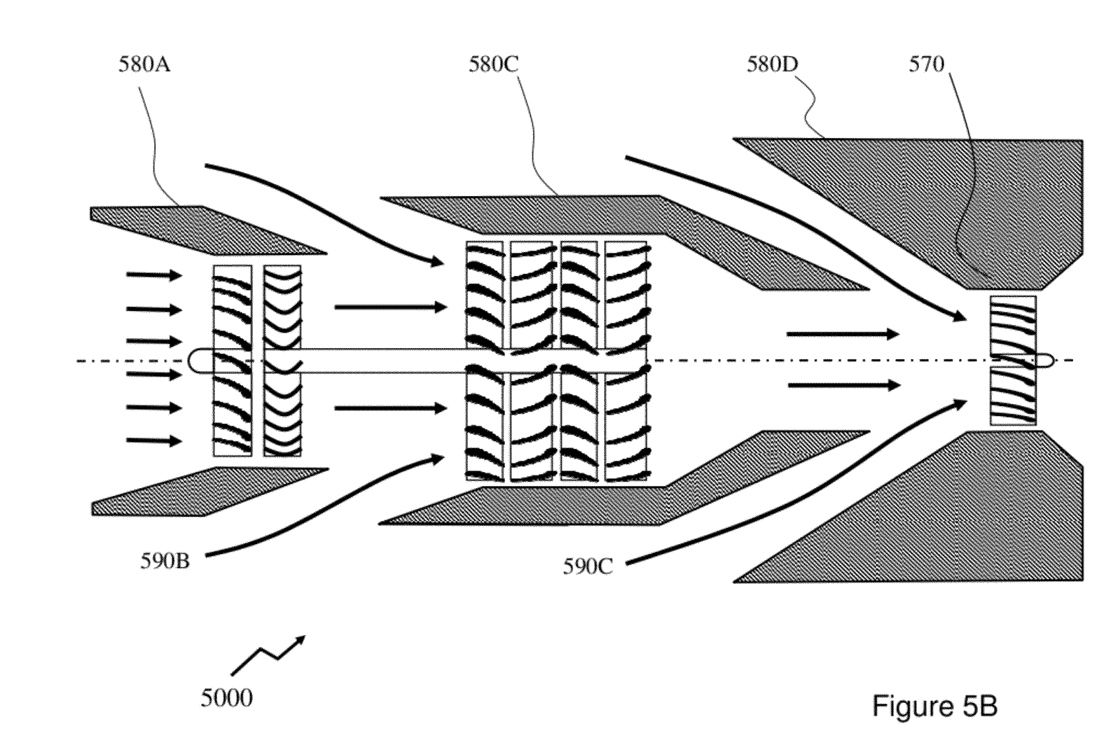

Referring to FIG. 5A there is depicted a wind turbine 500 according to an embodiment of the invention. As shown the outer shroud is comprised of a first section 580A and second section 580B for the wind turbine 500 wherein a Venturi effect is provided at the input through a reduction in the inner diameter of the first section 580A therein increasing the air speed at the throat of the wind turbine 500 where the air 590A initially impacts stator 510 that directs the air flow onto rotor 520 therein inducing rotation of the shaft 525 within the air turbine 500. The air flowing past stator 510 and rotor 520 then impacts in sequence first compression blade 530, first static blade 540, second compression blade 550, and second static blade 560 that act to increase the air flow through the compression of the air therein creating a draw effect from the throat of the wind turbine 500. The high speed compressed air now exiting the second static blade 560 impacts generator blade 570 causing it to rotate and generate electricity through the known dynamo/generator effect of a coil and magnet rotating relative to one another. The generator not shown for clarity.

However, unlike wind turbine 300 with a single continuous shroud 300 the wind turbine 500 has first and second sections 580A and 580B. The resulting channel within the outer shroud between rotor 520 and first compression blade 530 with increased air flow from the preceding Venturi effect results in a reduced pressure in between the rotor 520 and first compression blade 530 thereby causing secondary air flow 590B to be drawn into the wind turbine 500 increasing the overall air in the second stage of compression and generation. Further second section 580B undergoes a reduction in diameter between the second static blade 560 and generator blade 570 thereby increasing the compressed air speed even further.

Now referring to FIG. 5B there is depicted a wind turbine 5000 according to an embodiment of the invention with forced entrapment now provided at two stages. Accordingly the second section 580B of the shroud for wind turbine 500 is now replaced by third and fourth sections 580C and 580D respectively that provide a route for tertiary air flow 590C between them as air is pulled through the entrapment effect of the moving air within the wind turbine 5000.

It would be apparent to one skilled in the art that wind turbines 500 and 5000 may be augmented in similar manner to that of wind turbine 4000 in FIG. 4B supra in that multiple turbines may be employed rather than the single generator blade 570 depicted.

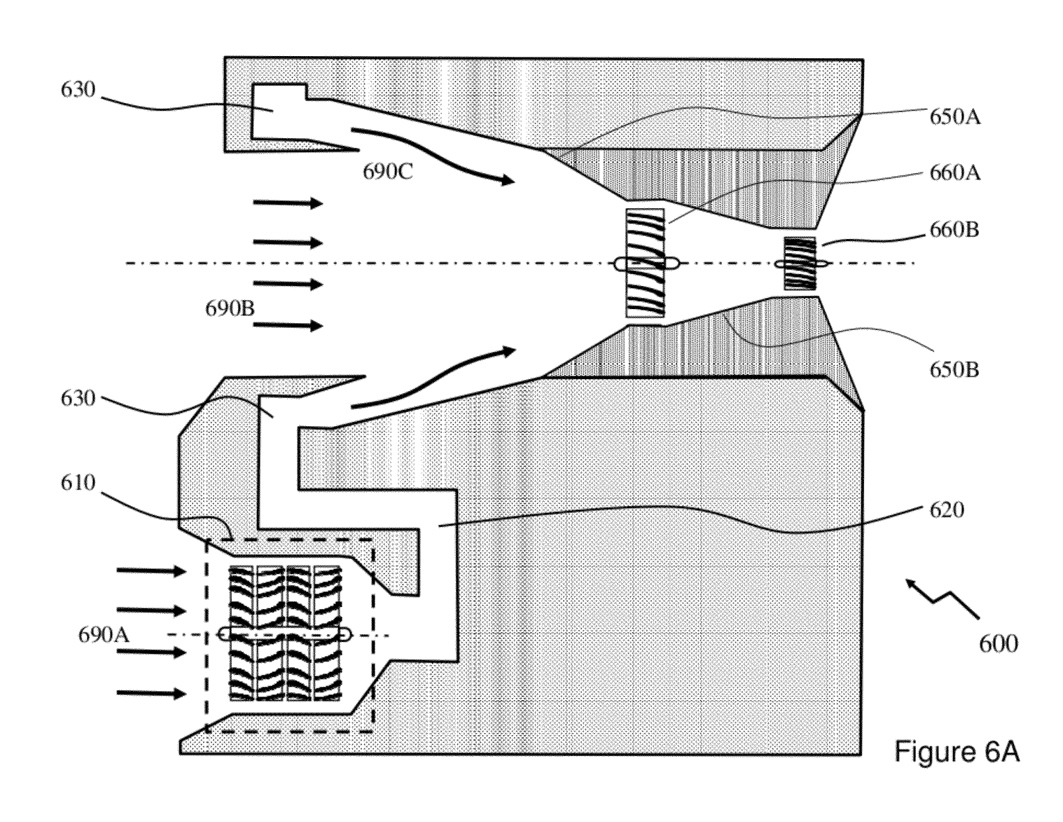

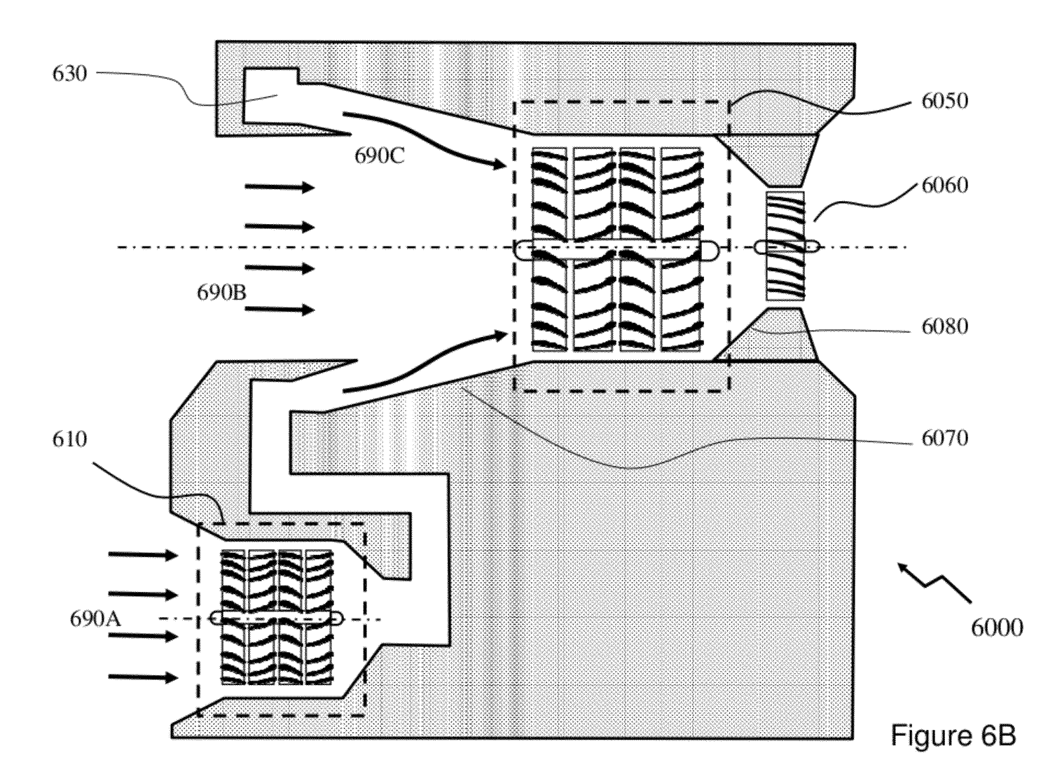

Now referring to FIG. 6A there is depicted a wind turbine 600 according to an embodiment of the invention with forced entrapment. Accordingly a first stator—rotor assembly 610 receives air flow 690A and pressurizes the flow before channeling it into duct 620 of the wind turbine 600. Duct 620 feeds an annular orifice 630 in the wind turbine 600 that feeds air flow 690C into the wind turbine 600 thereby entrapping air flow 690B at higher velocity thereby creating a pressure reduction at the front of the wind turbine. The combined air flows 690B and 690C are then directed to a first tapering bore 650A, coupled to first turbine 660A, second tapering bore 650B and second turbine 660B in series.

Accordingly the combined air flows 690B and 690C increase velocity at each stage overcoming reduction in velocity arising from the initial mixing and subsequent impacting of first turbine 660A. It would be evident to one skilled in the art that the number of turbines in the wind turbine may be increased further and that these may be used in combination with varying central bore diameter or fixed bore diameter. It would also be evident that turbines may be placed within the tapering section of a wind turbine which may or may not require design modifications to the turbine blades.

Now referring to FIG. 6B there is depicted a wind turbine 6000 according to an embodiment with forced entrapment. Accordingly, as with wind turbine 600 in FIG. 6A a first stator—rotor assembly 610 receives air flow 690A and pressurizes the flow before channeling it into duct of the wind turbine 6009 and therein feeding the annular orifice 630 in the wind turbine 6000 that feeds air flow 690C into the wind turbine 6000 thereby entrapping air flow 690B at higher velocity thereby creating a pressure reduction at the front of the wind turbine. The combined air flows 690B and 690C are then directed to a first tapering bore 6070 wherein they are coupled to compressor 6050, into second tapering bore 6080 and thence to turbine 6060. It would be evident that multiple turbines may be provided within the wind turbine 6000 with or without additional tapering of the wind turbine bore as presented supra in respect of FIGS. 4A and 4B.

Within the descriptions for wind turbines supra in respect of FIGS. 3 to 6B the generator associated with each turbine or generator blade has not been explicitly defined. It would be evident to one skilled in the art that these may be deployed in many embodiments as presented within the prior art including but not limited to Susman in US Patent Application 2005/0,001,432; Corcoran et al in U.S. Pat. No. 7,116,005; Uzzell in U.S. Pat. No. 3,883,750 and Finney in U.S. Pat. No. 5,464,320; Wikipedia (http://en.wikipedia.org/wiki/ElectricaLgenerator); and Danish Wind Industry Association (http://guidedtour.windpower.orglen/tour/wtrblelectric.htm).

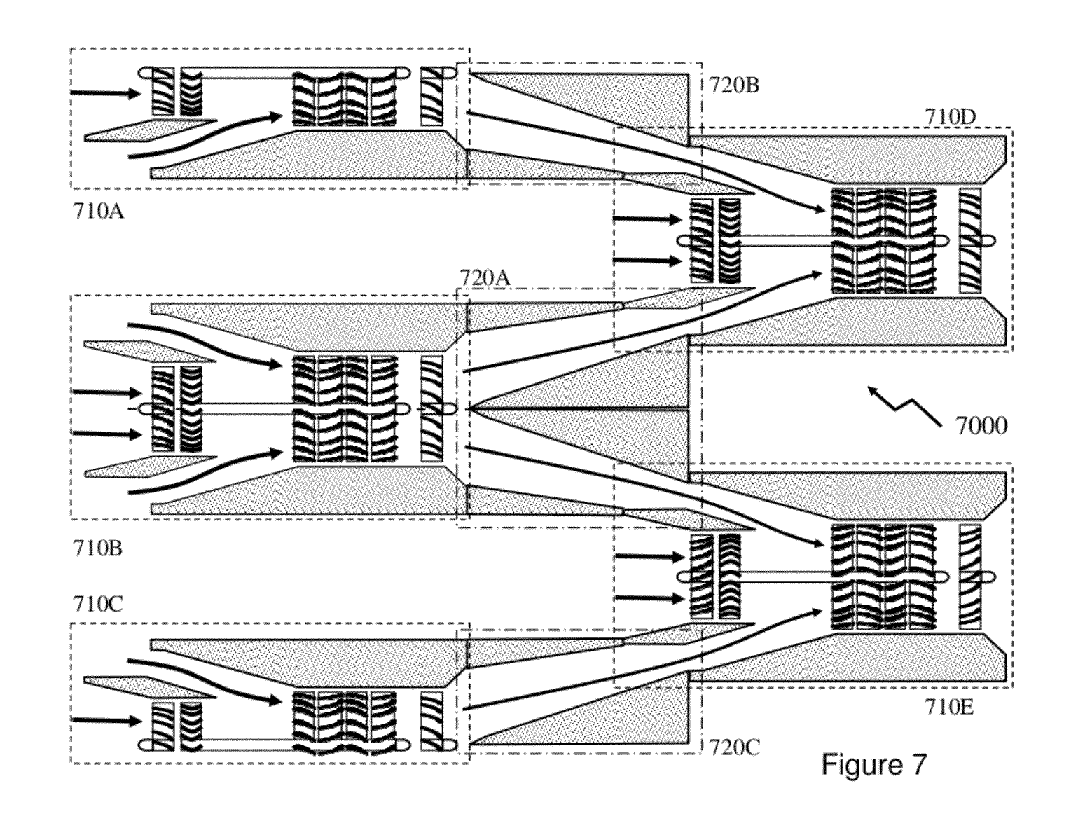

Referring to FIG. 7 there is depicted a wind turbine array according to an embodiment of the invention wherein a basic turbine unit 710x is repeated but provides dual functionality. Accordingly as depicted a first sub-array of turbine units 710A, 710B and 710C of a design such as wind turbine 400 of FIG. 4A are disposed receiving incoming air, providing shaft rotation through an initial stator-rotor assembly before the air flow is compressed and impacts the turbine blade. Each first sub-array of turbine units 710A, 710B and 710C also receiving through the annular opening entrapped airflow. The output from each of the first sub-array of turbine units 710A, 710B and 710C is then directed to two turbine units of a second sub-array of which only turbine units 710D and 710E are depicted. Accordingly, the output of turbine unit 710B is coupled to first turbine unit 710D and second turbine unit 710E of the second sub-array by first flow director 720A. Likewise part of the airflow from turbine unit 710A is directed to first turbine unit 710D by second flow director 720B (partially shown) and part of the airflow from turbine unit 710C is directed to first turbine unit 710E by third flow director 720C (partially shown).

Whilst FIG. 7 depicts a one-dimensional array of turbine units, either horizontal or vertical, it would be evident to one skilled in the art that a two-dimensional array may be deployed either by simple stacking the one-dimensional arrays as discrete uncoupled elements or by linking them through a variant of the flow directors that couple in both directions such that each turbine in the second sub-array is coupled to three or more turbines in the first sub-array such that removal of one turbine in that first sub-array for maintenance, bird strike etc does not reduce the overall array performance as significantly.

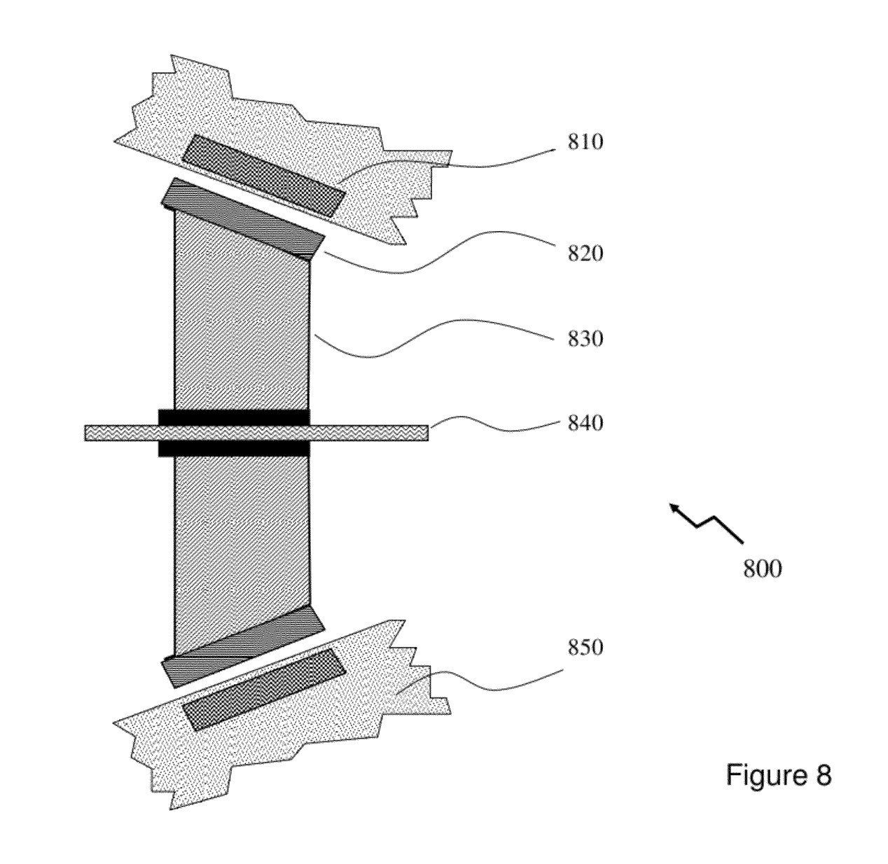

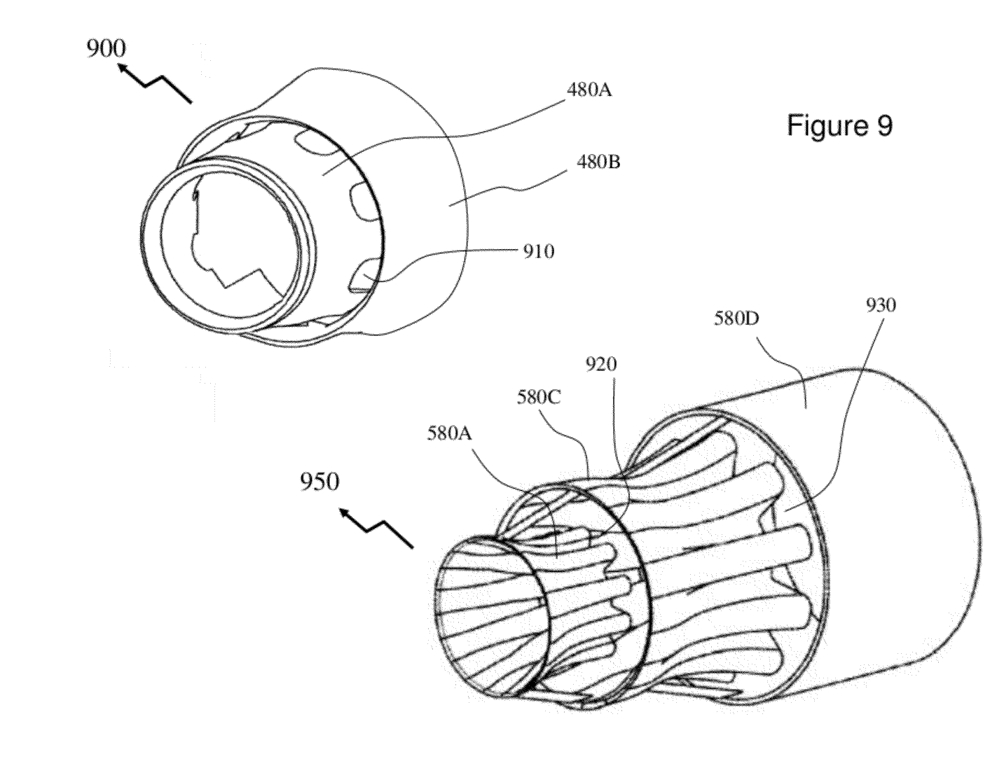

In order to reduce the mechanical complexity of the wind turbines wherein the generator is mounted axially within the wind turbine and alternative embodiments of the invention is depicted in FIG. 8 for the generator wherein a shaft 840 has mounted upon it blade vanes 830 that have permanent magnet tips 820. As such when the blade vane 830 rotates the permanent magnet tip 820 moves relative to a coil 810 embedded into the casing 850. As shown the permanent magnet tips 820 and blade vane 830 are profiled to match the tapering inner geometry of the casing 850 providing the increased air velocity through the Venturi effect. It would be evident that the permanent magnet tips 820 and blade vane 830 may be engineered for constant inner geometry of the casing 850 as well. Accordingly, it would also be evident to one skilled in the art that the multiple turbines/generator blades described supra in respect of different embodiments of the invention may exploit such blade/turbine designs. Further where multiple turbine/generator blades are depicted supra in respect of FIGS. 3 to 7 within constant diameter bore structures of the wind turbine it would be apparent that a tapering bore design may also be deployed without departing from the scope of the invention.

Within the descriptions presented supra in respect of FIGS. 4A through FIG. 7 there has been presented the concept of air entrapment wherein air from outside the turbine is pulled into the turbine through access channels in the shroud. It may be evident to one skilled in the art that such access channels may be simple slots with rounded corners, blunt corners, sharp corners etc according to the design implemented. However, these access channels may also be designed to ensure that the mixing of two air flows, e.g. primary and secondary air flows 490A and 490B respectively in FIG. 4A, of reduced turbulence. Accordingly first cowl design 900 depicts such a modified linear access slot has been modified through computer aided design to include an array of ports 910 in addition to the gap between first section 480A and second section 480B. Second cowl design 950 depicts a design compatible with wind turbine 5000 in FIG. 5B wherein the shroud is composed of three sections 580A, 580C, and 580D. Accordingly the annular ring is between first section 580A and second section 580C is modified by the inclusion of first flow channels 920 into the outer surface of first section 580A as it enters second section 580C. Similarly the annular ring is between second section 580C and third section 580D is modified by the inclusion of second flow channels 930 into the outer surface of second section 580C as it enters third section 580D. Such mixer designs for example being taught by Presz in U.S. Pat. No. 5,761,900 entitled “Two-Stage Mixer Ejector Suppressor”, Hauser in U.S. Pat. No. 6,012,281 entitled “Noise Suppressing Fluid Mixing System for a Turbine Engine” and Presz et al in U.S. Pat. No. 6,233,920 entitled “Contoured Thrust Reverser and Lobed Nozzle Noise Suppressor for Gas Turbine Engines.” Such mixers being taught as reducing the noise from jet engine exhausts through the improved mixing and flow resulting from their profiled geometry.

Within the embodiments described above in respect of FIGS. 3 though 7 the shaft connecting the rotor at the front of the turbine to the compressor section in the central portion of the turbine has been shown as a single element. It would be apparent to one skilled in the art that alternative designs may exist include linked designs allowing the front rotor/stator assembly to tilt into the wind without moving the entire turbine or that a gearbox may be employed between the shaft of the rotor and the compressor unit.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a first rotor for receiving an air flow and generating rotation of a first shaft in dependence upon the first rotor rotating with the air flow;
providing a second shaft having at least a first compressor rotor coupled to the first shaft wherein the first compressor rotor acts to adjusted a characteristic of the air flow after the first compressor rotor to create an adjusted air flow;
providing a turbine rotor receiving the adjusted air flow and rotating a third shaft at a rate established in dependence upon at least the adjusted air flow;
providing a generator providing an electrical output in dependence upon the rotation of the third shaft.

2. The method according to claim 1 wherein;
the first shaft and second shaft at least one of the same shaft, coupled by a universal joint, and coupled by a gearbox.

3. The method according to claim 1 further comprising;
providing a casing wherein the casing has a first inner diameter at the first rotor, a second inner diameter at the first compressor rotor and a third inner diameter at the turbine rotor wherein at least one of the second inner diameter and the third inner diameter is smaller than the first inner diameter.

4. The method according to claim 3 wherein;
the first inner diameter is smaller than the inner diameter of the casing at its front where air initially enters the casing.

5. The method according to claim 3 wherein;
the casing comprises an air entry port, the air entry port disposed at least one of between the first rotor and first compressor rotor and the first compressor rotor and turbine rotor.

6. The method according to claim 5 wherein,
the air entry port is designed to at least one reduce a measure of turbulence from mixing of air entering through the air entry port with air already within the assembly and reduce noise.

7. The method according to claim 1 wherein;
the generator is either mounted axially with the turbine rotor or the turbine rotor comprises a predetermined portion of the generator.

8. The method according to claim 1 wherein;
the output air flow after the turbine rotor is coupled to a predetermined number of subsequent air turbines as their input air flow.

9. A method comprising:
providing a first compressor for receiving a first air flow and generating a compressed air flow therefrom;
providing an annular air outlet connected to the first compressor for receiving the compressed air flow and feeding the compressed air flow as an annular flow into a turbine shaft;
providing a turbine rotor disposed within the turbine shaft for receiving the annular air flow and entrapped air generated by the compressed air flow within the turbine shaft and generating a rotation of a first shaft in dependence upon the turbine rotor rotating with the mixed annular air flow and entrapped air;
providing a generator either linked to the turbine rotor or comprising the turbine rotor for generating an electrical output in dependence upon the rotation rate of the turbine rotor.

10. The method according to claim 9 wherein;
the turbine shaft has a first inner diameter at the input wherein the entrapped air enters and a second inner diameter at the turbine rotor wherein the second inner diameter is either equal to or smaller than the first inner diameter.

11. The method according to claim 9 further comprising;
a compressor disposed in front of the turbine rotor.

12. The method according to claim 10 wherein;
the turbine shaft has a diameter at the compressor intermediate to the first inner diameter and the second inner diameter.

13. The method according to claim 9 wherein;
the generator is either mounted axially with the turbine rotor or the turbine rotor comprises a predetermined portion of the generator.
